(19) United States
(12) Patent Application Publication
(10) Pub. No.: US 2025/0037051 A1
(43) Pub. Date: Jan. 30, 2025

(54) COGNITIVE AUTOMATION-ENABLED INTERACTIVE TASK COLLABORATION AND MANAGEMENT SYSTEM

(71) Applicant: Ajit Kumar Mohapatra, Bhubanehswar (IN)

(72) Inventor: Ajit Kumar Mohapatra, Bhubanehswar (IN)

(21) Appl. No.: 18/785,203

(22) Filed: Jul. 26, 2024

(30) Foreign Application Priority Data
Jul. 29, 2023 (IN) 202331051200
Jan. 11, 2024 (IN) 202431002270

(51) Int. Cl. G06Q 10/0631; G06F 40/58; G10L 13/08

(52) U.S. Cl. CPC G06Q 10/06316; G06F 40/58; G10L 13/08

(57) ABSTRACT

A cognitive automation-enabled interactive task collaboration and management system comprising a user-interface developed to be installed on multiple computing units 102 that are accessed by different users/organizations for performing different tasks, an input peripheral 103 integrated with the interface for allowing the user to register on the interface, a processing unit 101 linked with the interface for processing the user-selected task and assigns a co-worker with multiple bots to the user, in case of work management, a decision making module for assigning required bots under the co-worker based on task enlisted under project, in case of project handling, a server 106 linked with the interface for generating a list of concerned faculty/official and creates a 3D character of a concerned faculty/official for interacting with the user, an audio controller 105 integrated with the interface for allowing real-time communication of the user with the character by implementing natural processing language protocol.

### CROSS REFERENCE TO RELATED APPLICATION

This application claims the benefit of Indian Provisional Application No. 202331051200 titled “Artificial Intelligence-Based Interactive Learning System” filed by the applicant on Jul. 29, 2023 and Indian Provisional Application no 202431002270 titled “Artificial Intelligence-Based Interactive Learning System” filed by the applicant on Jan. 11, 2024, both of which are incorporated herein by reference in its entirety.

### FIELD OF THE INVENTION

The present invention relates to a cognitive automation-enabled interactive task collaboration and management system that utilizes generative artificial intelligence to provide an interactive platform to an organization or individual to perform multiple tasks in an optimized and automated manner by generating co-workers and customizable bots. In addition, the system focuses on providing a real-time solution to the organizations or individuals by providing and adapting to varying alternatives/options for performing different tasks.

### BACKGROUND OF THE INVENTION

Work management in a corporate setting involves the systematic coordination and administration of tasks, projects, and processes to achieve organizational goals efficiently. It encompasses planning, organizing, and controlling resources, including time, personnel, and technology, to optimize productivity and performance. Key components include setting clear objectives, delegating responsibilities, monitoring progress, and implementing tools and techniques such as project management software, collaborative platforms, and performance metrics. Effective work management ensures that projects are completed on time, within budget, and to the desired quality standards, fostering a productive and cohesive work environment.

Work allocation and meeting deadlines in a corporate environment often present several challenges like ambiguities in task descriptions or expectations leads to confusion and misalignment, resulting in delayed or sub-par performance. In addition, distributing too many tasks to certain individuals can lead to burnout, decreased productivity, and lower morale. Furthermore, factors like inadequate resources also play a vital role as lack of necessary tools, technology, or personnel can impede the ability to complete tasks efficiently and on time. Poor time management skills among employees can lead to procrastination, missed deadlines, and rushed, lower-quality work. Apart from corporates, students of educational institutions also face certain mismanagements related to identification topics/concepts that may need more clarification after each lesson. Even though the main goal of the instructor is to ensure that most of students are able to understand and articulate the key concepts of each lesson clearly. But still there is an understanding gap between the instructor and learners, wherein the learners usually ask the queries on repeated basis, which leaves the instructor irritated and sometimes, due to shyness the learners are not even able to ask the queries.

U.S. Pat. No. 6,101,481A discloses a method which describes managing a plurality of tasks to be carried out by a plurality of personnel, each of the tasks having identified task details relevant thereto, in which the method includes: identifying task personnel who will be directly involved in carrying out each task; allocating sole responsibility for each task to a task controller, and transferring task details to and/or between task personnel and controllers such that task details relevant to a task are provided to and accessible by only the task controller and the task personnel for the task; wherein recommendations for modifying task details relevant to a task can only be made by task personnel for the task, and wherein a task or task details for a task can only be modified by the task controller for the task and/or an administrator, the method utilizes a data processing assembly operable under the control of program means embodied on a machine-readable storage medium that provides a task management system for coordinating the plurality of tasks, and the task management system includes: transfer means for transferring the task details to and/or between the task personnel and controllers; recommendation protocol means for establishing a protocol that the recommendations for modifying task details relevant to a task can only be made by the task personnel for the task, and modification protocol means for establishing a protocol that the modifications to a task or the task details for a task can only be made by the task controller for the task and/or the administrator.

U.S. Pat. No. 5,395,243A discloses an interactive learning system used for learning an application program, such as a word processing program, provides three basic types of instruction including interactive audio-visual lessons, reference information, and practice in using the actual application program being learned. The reference information may include relatively detailed reference information, relatively brief reference information, and customized reference information generated via an electronic clipboard. The subject matter of the application program is subdivided into different subject matter areas or units, and the user of the system may select to receive lessons relating to any of the units. The interactive learning system provides three learning paths, one of which comprises completing all of the lessons in a unit and then using the features of the actual application program relating to the unit that was just completed to reinforce the instruction received by the user.

As per the discussion in above-mentioned prior arts, many systems and methods are known that are focused in providing a means for executing multiple corporate tasks, projects, individual tasks as per requirement. There are also systems which are dedicated towards providing learning platforms to the users. However, none of these conventional systems and platforms are capable enough to optimize and automate the process of task allocation and management by generating co-workers and customizable bots and also these existing platforms lack in providing solution regarding solving of doubts/queries of the user while learning and hence, the user needs different platforms for getting solution for task management and learning requirements.

In order to overcome the aforementioned drawbacks, there exists a need in the art to develop a single system that requires to be capable of providing solution for both task management and interactive learning. The developed system needs to optimize and automate the process of task allocation and management by generating co-workers and customizable bots as well as requires to provide solution to queries/doubts of a student relevant to any topic for clarifying concepts of the student.

### OBJECTS OF THE INVENTION

The principal object of the present invention is to overcome the disadvantages of the prior art.

An object of the present invention is to develop a system that utilizes generative AI for developing different co-workers and bots as per a user's requirement to automatically execute the user's task.

Another object of the present invention is to develop a system that efficiently handle projects with varying tasks by assigning different bots in an optimized manner for delivery of the projects.

Another object of the present invention is to develop a system a system that is capable of providing a user-interactive platform for aiding multiple users to learn about diversified topics with an enhanced audio-visual experience for better understanding.

Another object of the present invention is to develop a system that is capable of creating a 3D (three dimensional) character/avatar which resembles a concerned faculty/designated official required in the interactive session.

Another object of the present invention is to develop a system that organizes learning as well as management tasks for an individual and organization by utilizing artificial intelligence protocols in view of optimizing the tasks for the individual or organization.

Another object of the present invention is to develop a system that provides language learning module to allow users to learn different languages at varying proficiency level.

Another object of the present invention is to develop a system that is capable of allowing a user to upload contents including textual content/videos/blogs/bots which is verified and then updated on the system.

Yet another object of the present invention is to develop a system that is capable of connecting an individual or team with a concerned faculty or official while interacting in view of managing tasks.

The foregoing and other objects, features, and advantages of the present invention will become readily apparent upon further review of the following detailed description of the preferred embodiment as illustrated in the accompanying drawings.

### SUMMARY OF THE INVENTION

The present invention relates to a cognitive automation-enabled interactive task collaboration and management system that utilizes generative artificial intelligence protocols and tools for developing co-workers and bots to automate a user's task. In addition, the proposed system is also capable of handling projects by automating varying tasks related to the projects as well as manages/organizes interactive learning or doubt clearing session, conduct training or meeting in view of optimizing and managing tasks of an organization or individual.

According to an embodiment of the present invention, a cognitive automation-enabled interactive task collaboration and management system comprises of a user-interface installed on multiple computing units that are accessed by different users or organizations to perform different tasks, an input peripheral integrated with the interface for allowing the user to provide input regarding personal details of the users to register the user on the interface, wherein the interface displays multiple options concerned with varying tasks such as work management and learning, a processing unit linked with the interface for processing the user's input, in accordance to which the processing unit provides a list of sub-options for the user, in case the user selects work management, the processing unit allocates a co-worker to the user and assign multiple pre-programmed bots under the allocated co-worker for performing the user's task, a decision making module configured with the processing unit for assigning a required number of bots under the co-worker for automating multiple tasks enlisted under the project, in case the user-selects project management, a server linked with the processing unit for generating a list of concerned faculty or designated official available for interacting with the user regarding the user-selected task, in case the user-selected option corresponds to learning or initiating meetings/trainings and creates a 3D character/avatar that mimics facial expressions/gestures of the user-selected faculty/official while interacting with the user, an audio controller integrated with the interface for allowing real-time communication of the user with the character in the user's language.

While the invention has been described and shown with particular reference to the preferred embodiment, it will be apparent that variations might be possible that would fall within the scope of the present invention.

### BRIEF DESCRIPTION OF THE DRAWINGS

These and other features, aspects, and advantages of the present invention will become better understood with regard to the following description, appended claims, and accompanying drawings where:

FIG. 1 illustrates a schema diagram of a cognitive automation-enabled interactive task collaboration and management system;

FIG. 2 illustrates a flow chart representing methodological flow of information associated with the proposed system; and

FIG. 3 illustrates a block diagram representing components associated with the proposed system.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting.

While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

The present invention relates to a cognitive automation-enabled interactive task collaboration and management system that utilizes generative artificial intelligence for creating co-workers and bots to automate a user's task along with allowing the user to customize bots as per the user's requirement. The proposed system is also capable of handling projects having varying tasks by assigning different bots to optimize working of the project along with conducting learning, training or doubt clearing session or meetings by initiating real time communication between the user and concerned faculty or designated officials.

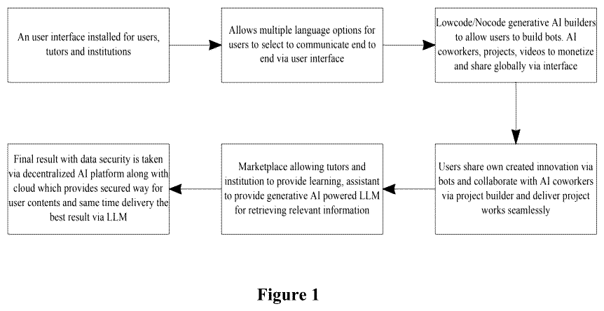

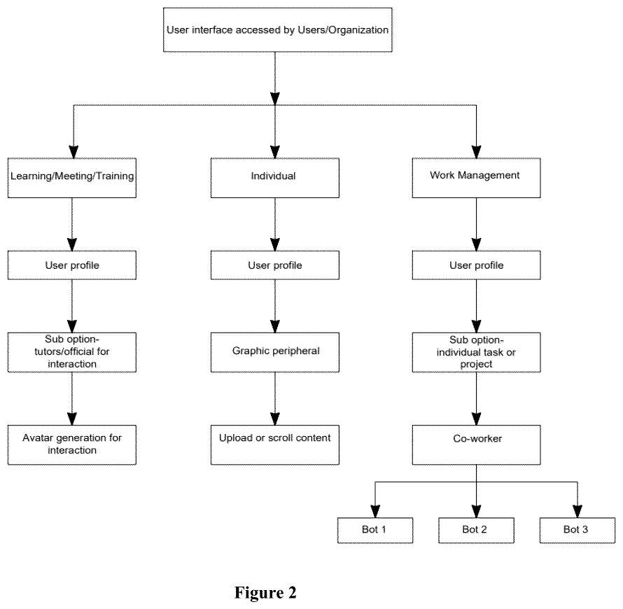

Referring to FIGS. 1 and 2, a schema diagram of a cognitive automation-enabled interactive task collaboration and management system and a flow chart representing methodological flow of information associated with the proposed system are illustrated, respectively.

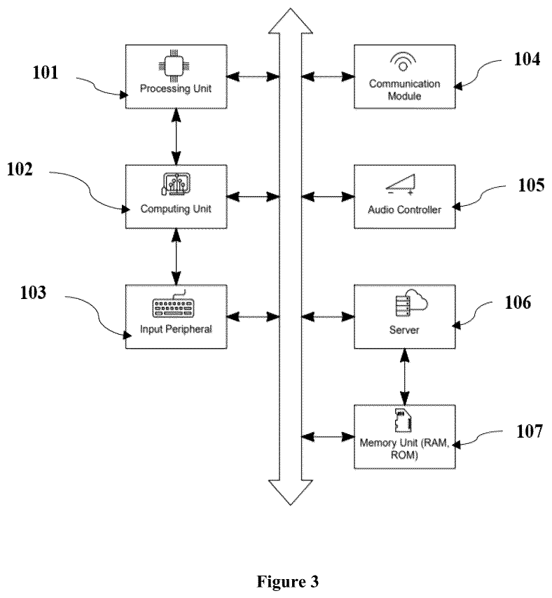

Referring to FIG. 3, a block diagram representing components associated with the proposed system is illustrated, respectively comprising a processing unit (multiple processors) 101, a computing unit 102, an input peripheral 103, a communication module (GSM) 104, an audio controller 105, a server 106 and memory unit (RAM, ROM) 107 associated with the processing unit 101.

The system comprises of a user-interface that represents an operating user-interactive platform installed on multiple computing units 102, wherein the computing units 102 includes a smartphone, laptop, tablet or any electronic gadget supporting the operating platform. The user-interface is designed in a manner to promote user-friendly interaction between the user and the interface. The user-interface is accessed by different users for performing different tasks, wherein the user includes individuals accessing the computing unit 102 for learning or interactive purpose as well as organizations utilizing the interface for conducting training session, meetings, handling projects or automated distribution of tasks to multiple co-workers based on their efficiency and area of expertise.

The interface is inbuilt with an input peripheral 103 that allows the user to type alphabets, numerals or special characters by means of a virtual or hardware keyboard configured with the computing unit 102. The input peripheral 103 is accessed by the user for providing input that corresponds to the user's identity details including national identity card and other details for registering the user's profile on the interface. On completion of the input of details by the user, a verification module operated by a processor is activated for verifying the user-input details by accessing online available databases, wherein upon successful verification of the user-fed details, the user profile is registered on the interface. Upon registration of the user on the interface, the interface prompts notifications to the user regarding tasks to be performed by the user on the interface by displaying multiple inbuilt options stored on the interface. Each of the options are concerned with assignment of tasks related to different domains, wherein the domains are majorly divided into three categories, i.e. business/organizational, academics and individual usage. The common tasks in all the domains includes automating task execution, handling projects, automation of work distribution, conducting training/meetings along with learning/doubt clearing sessions, wherein the difference lies in the format of processing the tasks.

For Organizations—In case the user-selected or preferred domain corresponds to organization/business, a processing unit 101 configured with the interface processes the user's selected option. The processing unit 101 includes one or more processors, memory unit (RAM, ROM) 107, control unit (CU) and an arithmetic logic unit (ALU) that acts as a building blocks of the processing unit 101 for executing different operations. On processing the user-selected domain, the processing unit 101 generates a list of relevant sub-options which is prompted to the user to make further selection. The prompted sub-options include varying kind of tasks related to automation of an individual task or project handling. With either of the sub-options, the processing unit 101 assigns a co-worker to the user which acts as a role agent for the user's profile for coordinating execution of the user's task. Every co-worker assigned under each of the users are allocated with a unique identification number (AlN) that serves as a name of the co-worker. The allocation of unique identification number to the co-worker introduces nomenclature of the co-workers which imparts precise management of co-workers in the interface along with eliminating any chances of dilemma in allocating co-worker to different users. This unique identification number of different co-workers also provides an additional edge to security level of the interface by capsulizing a particular user's data within the assigned co-worker having a specific identification number.

In case the user selected sub-option corresponds to an individual task, the interface offers a set of pre-programmed bots to the user which are accessed by the user for performing the user's task. Each of the bots represents different pre-programmed modules developed to perform specific tasks based on a set of instructions that are altered by the user. These bots are pre-programmed through generative AI (artificial intelligence) that refers to a class of artificial intelligence protocols and models which generates new data or content based on input data. These protocols are adapted to learn patterns from a given dataset and accordingly produces new instances of similar data. The interface also provides a provision for enabling the user to use a third party API (Application Programming Interface) endpoints to customize the bots to meet the user's requirement. These bots are developed by implementing bot builders which are one of the particular protocols to design feed-operative bots that allows the user to input requirements as per a user-desired task. These bots are inbuilt with a user-interactive feed that enables the user to provide the instructions as feed or input for executing the task. The user-fed instructions serve as basic parameters that are taken into consideration while executing the user's task. The user accessed bots are assigned under the co-worker as an entity performing under the guidance of the co-worker to perform the user-desired task.

In an exemplary embodiment, the user has a task of writing a research paper based on a set of data available with the user regarding a particular topic. The user is required to upload the available data in the feed along with instructions about the user-preferred format for the research paper, based on which the bots execute the task for drafting the research paper in the user-specified format.

In case the user selected sub-option corresponds to project handling, the user is required to provide details of the tasks enlisted under the project, in accordance to which the processing unit 101 scrutinizes the assigned bots allocated under the co-worker to evaluate working capability or compatible tasks that are feasible to be performed by the assigned bots. The processing unit 101 is inbuilt with a decision-making module that is encrypted with procedures or frameworks by which choices or selection of action are made based on objectives and the user-fed input. Common aspects and protocols involved in decision making for generative AI includes objective setting, input processing, model inference, evaluation/selection, iterative refinement, uncertainty management, feedback incorporation and ethical safety considerations. Before making decisions, the AI module defines objectives or goals, followed by processing input data to understand the context and constraints for making the decision.

Based on the input and learned model, the AI module generates new data or content which involves leveraging the trained parameters and architectures (like neural networks) to produce outputs that meets the defined objectives. After generating potential outputs, the AI module evaluates outputs against predefined criteria which may be based on metrics such as quality, coherence, realism or relevance. The outputs often undergo iterative refinement for generating multiple versions of an output and refine them based on feedback loops or additional criteria until an acceptable result is achieved. The generative AI module also incorporates mechanisms to manage uncertainty by involving techniques like sampling multiple outputs (in variational autoencoders) or providing confidence intervals or probabilities associated with the generated outputs.

In some cases, the AI module incorporate feedback from users or from external sources to improve decision making. This feedback is used to update models or adjust parameters to better align with desired outcomes by considering ethical implications and safety measures. This includes avoiding biases in generated content, ensuring privacy and security and preventing misuse of AI-generated outputs. The decision making module is operated by one of the processors inbuilt with the AI module for scrutinizing the user's fed details to understand the user's requirement and accordingly assigns a required kind of bots inbuilt in the interface under the co-worker. The decision-making module also makes decision regarding the best fit bots compatible to perform different tasks enlisted under the project through generative AI (artificial intelligence) by implementing project builders. In this process of assigning tasks to best fit bots, the decision-making module assigns some new bots under the co-worker as well as allocate a few tasks to already assigned bots in view of ensuring optimum quality of work in an optimized scenario.

In an exemplary embodiment, the user has a project having a set of two tasks that are to be performed, wherein one of the tasks is to build a presentation while the other is to review an already built presentation. The decision-making module then dedicate one of suitable assigned bot to build the presentation while employ another bot suitable for reviewing the presentation in order to ensure quality of work delivered by each of the bots in minimal time duration. In case, the decision-making module finds no compatible bots among the assigned bots to execute the review of the presentation, the module fetches one of the compatible inbuilt bots pre-fed in the interface and assign that bot under the co-worker to perform the review task.

The tasks performed by each of the bots during individual task delivery or project delivery is stored in a cloud database linked with the processing unit 101. The Generative AI also enables the processing unit 101 to learn behavior of the user while instructing the bots to perform the tasks which is stored in the database. In case the processing unit 101 observes any such behavior or task requirement fed by any user on the interface in future, the processing unit 101 scrutinizes the database to fetch the trained bots which initially performed the task to execute similar task for optimizing the time duration for completion of tasks.

In an exemplary embodiment, a first user instructing or feeding inputs for requirement of a particular bot depicted a particular behavioral pattern based on the first user's selections or choices made while feeding in the parameters which is stored in the database. The processing unit 101 learns that a second user accessing the interface is showing a similar behavioral pattern as per the second user's selections and choices, the processing unit 101 fetches a trained bot which performed the first user's similar task for performing the second user's task in view of ensuring quality execution of task in minimal time duration.

The interface is integrated with a virtual assistant that serves as a chat box which is accessed by the user for taking assistance to inspect regarding any of the bots or performing any operation in the interface. The virtual assistant is pre-fed with informative details associated with the interface including available bots, number of co-workers, designated sections on the interface for performing different operations, in accordance to which it assists the user in proceeding with searching for the bot or performing any relevant operation on the interface.

For Academics—In case the user-selected or preferred domain corresponds to academics, the interface initiates the academic module by displaying learning options to the user. The learning options includes multiple subjects and informative topics out of which the user is to select the topic to be learned by the user. Upon selection of the topic, the processing unit 101 processes the user's input and displays a list of faculties concerned with the user-selected topic. The user is required to select one of the displayed faculty for virtually interacting with the user to teach the user-selected topic to the user.

In an exemplary embodiment, the user-interface displays a list of subjects including history, geography, mathematics and computer science as sub-options to proceed with. Out of these subjects, say the user selects mathematics for learning purpose, wherein upon selecting mathematics a list of sub-topics including arithmetic, algebra or statistic is prompted to the user for further selection. Upon selecting algebra, the processing unit 101 displays a set of algebra teachers or professors enlisted on the interface for interacting with the user to teach algebra to the user.

Upon selection of the user-desired faculty, the processing unit 101 accesses a server 106 wirelessly linked with the processing unit 101 to generate an animated 3D character also known as avatar of the user-selected faculty by accessing an online available 3D character generating protocol. The generated avatar is customized in a detailed and precise format by fetching every minute detail of the user-selected faculty in a manner that the generated avatar is capable of mimicking facial expressions/gestures of the faculty. This detailing in the characteristic of the avatar provides the enhanced audio-visual experience of the user while interacting with the user. The content related to the topic to be taught to the user by the avatar is fetched from an online database by the processing unit 101 in textual form. The interface also provides a provision for allowing the user to customize appearance of the generated avatars as per the user's preference in view of enhancing engagement of the user with the interface.

The interface is encrypted with a text-to-speech converting module that converts the fetched textual content into speech form. The processing unit 101 is encrypted with a Natural Language Processing (NLP) that employs several artificial intelligence models like Named Entity Recognition (NER) and sentiment analysis focused on interaction between computers and human language. This involves developing protocols and models to enable computers to understand, interpret, generate and respond to human language in a meaningful and useful manner by referring to a multi-lingual database linked with the processing unit 101 and stored with scripts of different languages to aid in identification, conversion of words and sentences into varying languages. Conversion of language through NLP is implemented for initiating conversion of the character's language into the user's language to promote healthy communication between the user and the avatar. The protocol imparts multi-language support to the interface that allows the user to communicate or access the interface in a user-desired language. The converting module is encoded with a high-quality speech synthesis protocol for creating a natural-sounding voices of the avatar during the interaction. For example, the sound of avatar is a female voice, then the high-quality speech synthesis unit increases the pitch of the sound for creating a natural-sounding voices for better clarity of the wordings of the avatar during the interaction.

The interface is inbuilt with an audio controller 105 that enables the user to interact with the avatar by providing voice input. The audio controller 105 or audio API (Application Programming Interface) facilitates access to the computing unit's audio peripheral, i.e. speaker and microphone for various functionalities such as recording audio input from the microphone, playing audio through speakers or manipulating of audio input or output streams for initiating real-time communication between the user and the avatar. This also aids in storing of the conversion of the user with the avatar for training, reference or learning purposes.

The virtual assistant is also accessed by the user for entering the user's queries/doubts in textual form. The virtual assistant represents a dialogue management unit encrypted with the processing unit 101 that saves the overall conversation of the user in the database linked with the processing unit 101. The processing unit 101 then fetches data regarding the user's entered queries/doubts from the virtual assistant and accesses the database for fetching relevant answers to the user's queries/doubts. The fetched data is then converted into speech form by implementing the text-to-speech converting module, which is then pronounced by the avatar to the user while teaching the user regarding the relevant topic for enhancing audio-visual experience of the user.

The processing unit 101 is integrated with a communication module 104 for establishing a wireless connection between the processing unit 101 and the faculty registered on the interface. The communication module 104 includes but not limited to GSM (global system for mobile communication) for establishing network to connect the smartphone of the faculty in same range as that of the interface. The integrated communication module 104 tested for ensuring correct connectivity with different devices and network connections by testing edge cases such as simultaneous calls, call interruption and user-interaction during calls. Depending on the interface requirements, VOIP libraries/Frameworks like Twilio, SIP.js or WebRTC implementations (say SimpleWebRTC), backend technologies like Node.js, Django, Flask for setting up the backend server infrastructure to handle user authentication, database operations and call management logic, frontend development for ensuring display of user contacts, initiating calls and handling call status updates with real-time communication libraries for voice calling functionalities. In case, the user desires to initiate personalized meeting experience with the faculty, the interface establishes wireless connection of the user with the concerned faculty via video call for enhanced learning experience of the user. In an embodiment, the communication may include wireless connectivity i.e. Wi-Fi, or other similar modes of communication covering short range and long range communication modes.

In a similar manner, in case the user-selected or preferred domain corresponds to conducting meetings or trainings in a registered institution or organization, the interface displays a list of designated officials available for interacting with the user for the meetings or trainings. Based on the user-selected officials, the processing unit 101 generates an avatar of the user-selected official to conduct the meeting or training session with the added members in similar natural sounding voice and facial expressions of the concerned official to maintain overall audio-visual experience of the organization members with the designated official. The members are also capable of raising their inputs/queries/doubts during the meeting in the virtual assistant which is replied by the official's avatar during the meeting/training based on the organization policies pre-fed in the cloud database linked with the processing unit 101. In case, the user's input/queries/doubts require immediate contact with the concerned official, the processing unit 101 initiates a wireless contact with the official by initiating video call with the concerned faculty or any other faculty responsible for replying to the entered input.

In an exemplary embodiment, the user interface displays an option such as name of departments of an organization where meetings and trainings are to be conducted along with name of members involved in the meetings or trainings. Based on the user-selected department and members, the interface prompts a list of designated officials including team leads/assistant managers or managers concerned for conducting the meeting or training.

For individual—The user-interface is inbuilt with a graphic peripheral that is accessed by the user for uploading contents on the interface including videos, blogs or textual content. The uploaded content is verified by utilizing blockchain solutions that involves leveraging decentralized and immutable nature of blockchain technology to ensure that the content remain unchanged and is verified. Based on the requirements of interface, scalability, development tools inbuilt in the interface, the blockchain platform is selected from Etherum, Hyperledger Fabric, Binance Smart Chain. Upon successful verification of the uploaded content, the content is shared in a particular section of the interface. This particular section of the interface is accessed by the user individually for accessing the uploaded content on the interface for learning purpose.

The processing unit 101 is encrypted with high data security tools for security, transparency and innovation in the interface along with ensuring privacy and security. The tool is selected from a list of APE (Analytics and Policy Engine), Owasp (Open Web Application Security Project) API (Application Programming Interface) or AES (Advanced Encryption Standard) that works for Open threat management and processes high-volume and high-velocity data in real time while feeding threat intelligence, behavioral anomalies, historical context and vulnerability scan results to dynamic threat models driven by actionable AI (artificial intelligence) and ML (machine learning) based correlation.

The interface also utilizes block chain platform for securely sharing the content in view of ensuring that the data shared on the interface is not shared without consent of the user to maintain integrity of the user-interface. The block chain platform also prevents tampering or unauthorized access of the user's data. For additional security and privacy of data capsulated under the co-workers and bots, the interface offers a decentralized artificial intelligence-based platform as a second option for enhancing confidentiality and privacy of the data. The chance of opting for decentralized AI platform prioritizes decentralization by eliminating streamline control and offering improved privacy, resilience and scalability with no dependency on a single authority. The decentralized platform utilizes blockchain as a service for offering encrypted coin which acts as a utility coin that is assigned to the user's co-worker under the co-worker's unique identification number (UIN). These utility coins are potent for being used as a means for initiating exchanges, rewarding contributors or transactions via the interface.

The interface also offers a language learning module for allowing multiple users to learn different languages in an interactive manner. The language training session facilitates training of language at every proficiency level by conducting lessons, interactive sessions and providing real-time feedback that aids in efficient learning of the language along with enhancing the user's skill in reading, writing and speaking.

In an embodiment of the present invention, during registration of the user's profile on the interface, a OTP (one time password) is prompted on the user-specified phone number or email-ID for verification. Upon entering of the same OTP in the interface within a time duration, the processing unit verifies the user's number or email-ID with respect to the user's profile which is saved in the database as contact details of the registered user in the interface.

In an embodiment of the present invention, the interface is designed in a manner to allow accessibility of the users with disabilities by allowing understanding in the words or sentences used with the user's conversation in order to increase usability or scalability of the interface. The processing unit is capable of accessing camera of the computing unit for viewing facial expressions of the user for predicting the user's behavior while interacting with an avatar in view of performing behavioral analysis of the user for proper understanding of the user's words or sentences in case the user-prompted words or sentences are not clear.

In an embodiment of the present invention, the interface also provides a provision to register a cloud institute on the interface by uploading educational content, tutorial session or doubt clearing session timing for a number of learners, wherein the learners include students, corporate workers enhancing their skills or individuals opting new courses. The uploaded educational content also includes customized videos or textual content.

In an embodiment of the present invention, the uploaded content on the interface increases knowledge base of the interface. The interface requires a comprehensive knowledge base that stores educational content, textbooks, articles and other relevant information related to varying topics and approaches. The knowledge base is constantly updated to maintain an appropriate up to date answers or content related to varying topics. Machine learning protocols are implemented in the interface to generate appropriate responses to the user's queries. The shared or uploaded content including textual content, shared blogs and generated models may be available for public sharing to enhance awareness of public on a specific topic or enhance public knowledge regarding any specific topic.

In an embodiment of the present invention, in case general queries asked by the user is not available in the database, a connection is established between the server and the processing unit. Upon connection establishment of processing unit with the server, the microcontroller sends a HTTP (Hyper Text Transfer Protocol) request over the server to fetch the solution of the user's doubt/queries. Upon receiving request from the microcontroller, the server accepts the requested process and deliver HTTP (Hyper Text Transfer Protocol) the accurate answers/content of doubt/queries to the processing unit in response to the user's doubt/queries.

In an embodiment of the present invention, the user is able to customize the appearance of the characters as per requirement such as the facial shape, skin tone, hairs, hair color etc. of the characters as means of enhancing the appearance of the characters. The user or the registered faculty/managers/team leads are also capable of selecting an icon picture for their profile for being displayed on the interface.

Although the field of the invention has been described herein with limited reference to specific embodiments, this description is not meant to be construed in a limiting sense. Various modifications of the disclosed embodiments, as well as alternate embodiments of the invention, will become apparent to persons skilled in the art upon reference to the description of the invention.

I/We claim:

1. A cognitive automation-enabled interactive task collaboration and management system, comprising:
i) a user-interface developed to be installed on multiple computing units 102, wherein said interface is accessed by different users/organizations via said computing units 102 to execute different tasks;
ii) an input peripheral 103 inbuilt in said interface that is accessed by said users/organizations for providing input regarding a set of details for creating a profile on said interface, wherein said interface is pre-fed with options concerning tasks related to work management and learning, out of which said user selects a required task;
iii) a processing unit 101 configured with said interface for processing said user's selection and accordingly displays relevant sub-options to allow said user to select any of said displayed sub-options to proceed with, wherein in case said selected option corresponds to work management, said processing unit 101 allocates a co-worker with a unique identification number (AlN), for said user in view of guiding said user regarding development of varying kinds of pre-programmed bots to automate said user's task, wherein each of said bots are incorporated with a user-interactive feed for allowing said user to feed in details that serves as basic parameter for executing said user's task;
iv) a decision making module operated by one of processors configured with said processing unit 101 for assigning a required kinds of bots to said co-worker in view of automating said user's task, wherein each of said assigned bots are developed for performing an individual task, wherein in case said selected sub-options corresponds to projects delivery, said module in sync with said processing unit 101 coordinates requirements of said project and accordingly assigns/re-assigns specific bots to be involved for working on said user's project in order to optimize results for delivery of the project;
v) a server 106 linked with said processing unit 101 for generating a list of concerned faculty or designated official available for interacting with said user regarding said user-selected task, in case said user-selected option corresponds to learning or initiating meetings/trainings, wherein based on said user's selection, said processing unit 101 creates an animated character of said user-selected faculty/official by accessing an online available 3D character generating protocol, in view of enhancing audio-visual experience of said user for better understanding and communication; and
vi) an audio controller 105 integrated with said interface and linked with said computing unit's audio peripheral for allowing real-time communication of said user with said character, wherein said processing unit 101 is encrypted with Natural Language Processing (NLP) that initiates conversion of said character's language into said user's language to promote healthy communication between said user and character, in case said user selected option corresponds to learning or conducting meetings/trainings.

2. The system as claimed in claim 1, wherein a communication module 104 is integrated with said processing unit 101 for establishing a wireless contact between said processing unit 101 and plurality of authorized faculty/officials registered on said interface, wherein said user is capable of initiating contact with any of said registered faculty/officials, in case said user wants to initiate a personalized learning or meeting experience with any of said faculty/officials.

3. The system as claimed in claim 1, wherein a virtual assistant is inbuilt in said interface that is accessible by said user to input said user's queries/doubts while using said interface in textual form, in accordance to which said processing unit 101 guides said user regarding required operations to be performed by said user on said interface.

4. The system as claimed in claim 1, wherein said processing unit 101 is pre-fed with a multi-lingual database stored with script of different languages for fetching and translating words or sentences in different languages by implementing NLP.

5. The system as claimed in claim 1, wherein said tasks includes learning, conducting team meetings, projects delivery, individual tasks, training sessions or doubt-clearing sessions.

6. The system as claimed in claim 1, wherein said processing unit 101 is encrypted with high data security tools for privacy and security purposes.

7. The system as claimed in claim 1, wherein said computing units include but not limited to smartphone, laptop, tablet, electronic gadgets.

8. The system as claimed in claim 1, wherein said processing unit 101 is integrated with one or more processors, memory unit (RAM, ROM) 107, control unit (CU) and an arithmetic logic unit (ALU).

9. The system as claimed in claim 1, wherein a high-quality speech synthesis unit is encoded in said processing unit 101 for creating a natural-sounding voices of said characters during said interaction.

10. The system as claimed in claim 1, wherein said decision making module is a part of said processing unit, operated by one or more processors.
